(19) United States
(12) Patent Application Publication
(10) Pub. No.: US 2022/0163086 A1
(43) Pub. Date: May 26, 2022

(54) SHOCK ABSORBER

(71) Applicant: Hitachi Astemo, Ltd., Hitachinaka-shi (JP)

(72) Inventors: Daisuke IKEDA, Hitachinaka-shi (JP); Nao KADOTA, Hitachinaka-shi (JP)

(73) Assignee: Hitachi Astemo, Ltd., Hitachinaka-shi (JP)

(21) Appl. No.: 17/340,668

(22) Filed: Jun. 7, 2021

(30) Foreign Application Priority Data
Nov. 25, 2020 (JP) 2020-194937

(51) Int. Cl. F16F 9/16; F16F 9/50; F16F 9/32

(52) U.S. Cl. CPC F16F 9/165; F16F 9/50; F16F 9/3292; F16F 2222/12; F16F 2234/02; F16F 13/007; F16F 2230/08; F16F 2230/18; F16F 2222/06; F16F 2230/42; F16F 2232/08

(57) ABSTRACT

A shock absorber includes a hollow cylinder body extending in an up-down direction, a rod pipe located on an axis of the cylinder body, provided to be relatively movable in an axial direction of the cylinder body with respect to the cylinder body, and provided in a form of receiving a force in the axial direction, a rod-shaped support body extending inside the rod pipe with an upper end fixed, a stroke sensor including a coil and a conductor provided to be able to detect relative displacement of the rod pipe with respect to the support body, and a hollow intermediate member provided between the inner peripheral surface of the rod pipe and the support body to allow movement in the axial direction.

### CROSS-REFERENCE TO RELATED APPLICATIONS

This application is based upon and claims the benefit of priority to Japanese Patent Application No. 2020-194937, filed on Nov. 25, 2020, the entire content of which is incorporated herein by reference in its entirety.

### FIELD OF THE INVENTION

The present invention relates to a shock absorber suitable for use in a saddle-riding vehicle.

### BACKGROUND OF THE INVENTION

A shock absorber is used for a front fork of a saddle-riding vehicle such as a motorcycle and a tricycle. In the front fork, for example, in order to figure out a running state of the saddle-riding vehicle, it may be required to detect a stroke amount of the shock absorber, which is an expansion and contraction amount of the front fork. Such a shock absorber is known, for example, in Japanese Patent No. 6625791.

The shock absorber known in Japanese Patent No. 6625791 includes an outer tube with an upper end as a closed end and a lower end as an open end, an inner tube with an upper end as an open end and a lower end as a closed end where a part thereof is fitted to an inside of the outer tube to move forward and backward, a hollow rod extending from the upper end of the outer tube to an inside of the inner tube, and a piston fixed to the rod. The piston can generate a damping force when the inner tube moves forward and backward with respect to the outer tube.

The shock absorber described above also includes a stroke sensor which can detect a stroke amount associated with an advance and retreat amount of the inner tube with respect to the outer tube. The stroke sensor includes a hollow coil support body provided along an inner peripheral surface of the rod and a coil wound around an outer peripheral surface of the coil support body. Inside the coil support body, a rod-shaped conductor portion along an axis is provided. A lower end of a conductor portion is fixed to an axle side. By moving the inner tube relative to the outer tube, the conductor portion moves relative to the coil support body.

The rod provided in the shock absorber disclosed in Japanese Patent No. 6625791 has an upper end fixed to the outer tube and a lower end fixed to the piston. A general shock absorber has a structure which prevents an inner tube from coming off from an outer tube when extended to the maximum in an axial direction. For example, the rod receives an axial force (tensile force) when the rod impedes movement of the inner tube trying to escape from the outer tube. As described above, the rod disclosed in Japanese Patent No. 6625791 is provided inside the inner tube in a form of receiving an axial force. From a viewpoint of easily improving performance of the stroke sensor, it is preferable to construct the rod with a material having high magnetic permeability. However, among the materials having high magnetic permeability, there are materials which are difficult to satisfy strength conditions required for the rod. When the rod is constructed of such a material, durability of the shock absorber may be reduced.

An object of the invention is to provide a shock absorber provided with a stroke sensor having improved performance and durability.

### SUMMARY OF INVENTION

As a result of diligent studies, the present inventors have found that it is possible to improve performance of a stroke sensor by providing an intermediate member, which is made of a material with higher magnetic permeability than that of a rod pipe, between a rod pipe which is provided in a form of receiving an axial force of a shock absorber and can move in the axial direction and a coil provided inside this rod pipe. It was found that durability of the stroke sensor can be improved by providing the intermediate member in a form that allows movement in the axial direction. The invention has been completed based on such finding. The invention will be described below. In the following explanation, “provided in a configuration that receives an axial force” means that the shock absorber is provided in a form that prevents the shock absorber from moving in the axial direction by being fixed by other members provided around the shock absorber.

According to an aspect of the present invention, there is provided a shock absorber includes: a hollow cylinder body extending in an up-down direction; a rod pipe which is a hollow member located on an axis of the cylinder body, provided to be relatively movable in an axial direction of the cylinder body with respect to the cylinder body, and provided in a form of receiving a force in the axial direction; a rod-shaped support body extending inside the rod pipe with an upper end fixed; and a stroke sensor including a coil and a conductor provided to be able to detect relative displacement of the rod pipe with respect to the support body, wherein in the stroke sensor, the conductor is the rod pipe and the coil is wound around an outer peripheral surface of the support body, or the conductor is the support body and the coil is provided on an inner peripheral surface of the rod pipe, and the shock absorber further comprises a hollow intermediate member provided between the inner peripheral surface of the rod pipe and the support body to allow movement in the axial direction.

According to an another aspect of the present invention, there is provided a shock absorber comprising: a tubular outer tube with an upper end as a closed end and a lower end as an open end; a tubular inner tube with an upper end as an open end and a lower end as a closed end, where a part of the inner tube can move forward and backward with respect to an inside of the outer tube; a tubular cylinder extending from the upper end of the outer tube to an inside of the inner tube; a rod pipe, which is a hollow conductor, extending from the lower end of the inner tube to an inside of the cylinder and provided to be movable relative to the cylinder in an axial direction of the cylinder; a piston which is connected to an upper end of the rod pipe and divides the inside of the cylinder into a lower first liquid chamber and an upper second liquid chamber; a stroke sensor which includes a support body, which is a rod-shaped conductor extending from the upper end of the outer tube through the piston to an inside of the rod pipe, and a coil provided inside the rod pipe so that a relative displacement of the support body with respect to the rod pipe can be detected; a hollow intermediate member which is provided in a form that allows movement in the axial direction between an inner peripheral surface of the rod pipe and an outer peripheral surface of the coil and is made of a material having higher magnetic permeability than the rod pipe; a cable harness which is connected to the coil via a detachable connector and is guided to an outside from the upper end of the outer tube; and correction unit which is provided in the outer tube and corrects a position of the rod pipe with respect to the support body, where the position is detected by using the coil, based on a temperature, wherein the rod pipe has a first through hole which penetrates in a radial direction of the rod pipe at an upper end portion, the intermediate member has a second through hole which penetrates in a radial direction of the intermediate member at a lower end portion, and an inside of the intermediate member communicates with the first liquid chamber through the second through hole and the first through hole.

The invention can provide a shock absorber provided with a stroke sensor having improved performance and durability.

### BRIEF DESCRIPTION OF THE DRAWINGS

FIG. 1 is a side view of a motorcycle equipped with a front fork provided with a shock absorber according to a first example;

FIG. 2 is a cross-sectional view illustrating a main part of a hydraulic shock absorber forming the front fork illustrated in FIG. 1;

FIG. 3 is an enlarged view of the portion 3 of FIG. 2;

FIG. 4 is an enlarged view of the portion 4 of FIG. 2;

FIG. 5 is an enlarged view of the portion 5 of FIG. 2;

FIG. 6 is a perspective view illustrating a main part of a cable connection unit illustrated in FIG. 5;

FIG. 7 is a cross-sectional view illustrating one main part of a shock absorber according to a second example;

FIG. 8 is a cross-sectional view illustrating another main part of the shock absorber according to the second example;

FIG. 9 is a cross-sectional view illustrating a main part of a shock absorber according to a third example; and

FIG. 10 is an enlarged perspective view of a cable connection unit illustrated in FIG. 9.

FIG. 11 is a perspective view illustrating a main part of the cable connection unit illustrated in FIG. 10 by cutting.

### DETAILED DESCRIPTION OF THE INVENTION

Embodiments of the invention will be described below with reference to the accompanying drawings. The form illustrated in the accompanying drawings is an example of the invention and the invention is not limited thereto. In the explanation, left and right refer to the left and right based on an occupant in a vehicle and front and rear refer to the front and rear based on a traveling direction of the vehicle. In the drawing, Fr indicates the front, Rr indicates the rear, Up indicates the top, and Dn indicates the bottom.

### First Example

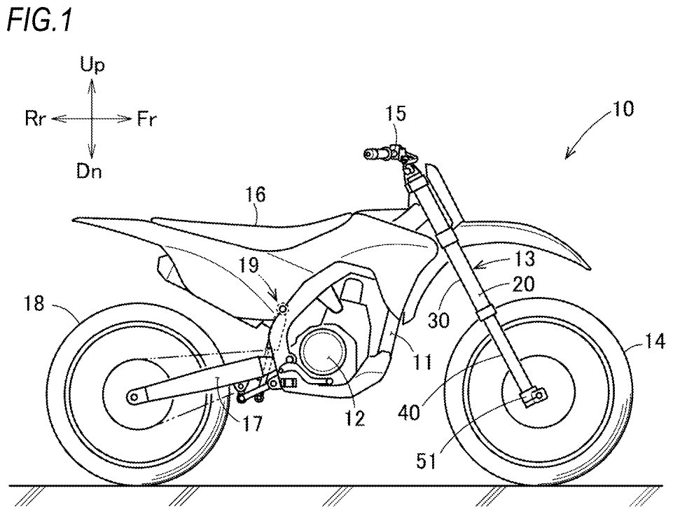

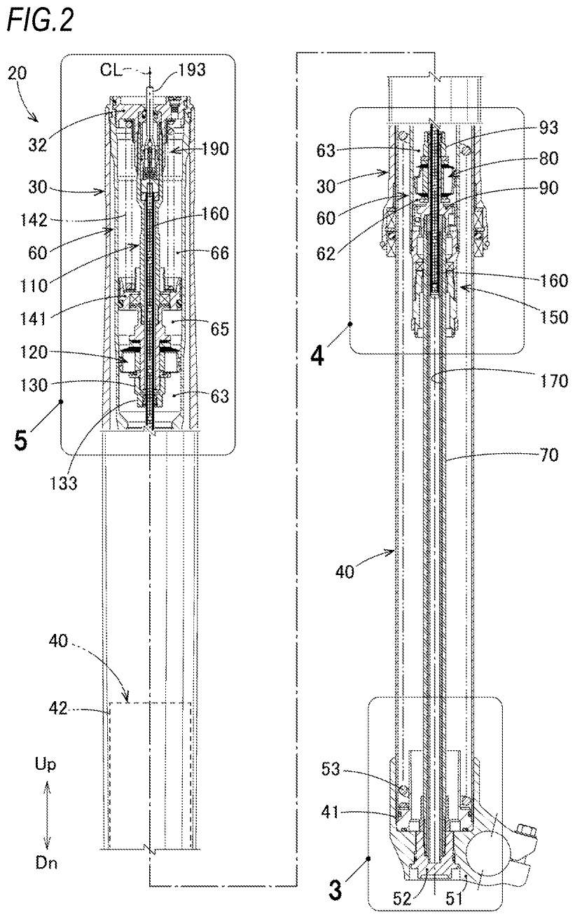

A shock absorber 20 of a first example will be described with reference to FIGS. 1 to 6.

As illustrated in FIG. 1, the shock absorber 20 is used in a saddle-riding vehicle on which an occupant rides, such as a motorcycle and a tricycle, and as an example, is a hydraulic shock absorber applicable to a front fork of a motorcycle.

A motorcycle 10 includes a vehicle body 11, an engine 12 which is a power source supported in a lower center of the vehicle body 11, a front fork 13 provided at a front of the vehicle body 11, a front wheel 14 which is a wheel supported by the front fork 13, and a steering bar 15 connected to the front fork 13. The motorcycle 10 is provided with an occupant seat 16 in an upper center of the vehicle body 11 and includes a wheel support mechanism 17 which extends rearward from a rear portion of the vehicle body 11 and can swing in an up-down direction, a rear wheel 18 which is a wheel supported by the wheel support mechanism 17, and a rear suspension 19 bridged between the vehicle body 11 and the wheel support mechanism 17.

Hereinafter, the shock absorber 20 applicable to at least one of two front forks 13 provided on both sides of the front wheel 14 will be described in detail.

As illustrated in FIGS. 1 to 5, the shock absorber 20 forms a so-called inverted type front fork having an outer tube 30 provided on the vehicle body 11 side and an inner tube 40 provided on the front wheel 14 side. The shock absorber 20 includes the outer tube 30, the inner tube 40, a suspension spring 53 whose lower end is present in the inner tube 40, and a cylinder 60 extending from an upper end 31 of the outer tube 30 to the inside of the inner tube 40. The shock absorber 20 includes a first rod 70, which is a hollow member extending upward from a lower end 41 of the inner tube 40, a first piston 80 fixed to an upper end 72 of the first rod 70, a second rod 110 extending from the upper end 31 of the outer tube 30 to the inside of the cylinder 60, and a second piston 120 fixed to a lower end 111 of the second rod 110.

A center line of the outer tube 30, the inner tube 40, the suspension spring 53, the cylinder 60, the first rod 70, the first piston 80, the second rod 110, and the second piston 120 is a center line CL (axis CL) and a direction along the axis CL is an axial direction of the shock absorber 20.

The outer tube 30 is a hollow cylindrical member, which extends in the up-down direction and has an upper end 31 closed by a fork bolt 32. The upper end 31 of the outer tube 30 is a closed end and a lower end 33 of the outer tube 30 is an open end. The outer tube 30 is appropriately referred to as a “hollow cylinder 30”.

The inner tube 40 is a hollow cylindrical member in which at least an upper end 42 is provided in the outer tube 30 and is provided to be movable relative to the outer tube 30 in the axial direction. A lower end 41 of the inner tube 40 is provided on an axle bracket 51 for supporting an axle for the front wheel 14 and a lower end 41 is closed by a bottom bolt 52. The lower end 41 is a closed end and the upper end 42 of the inner tube 40 is an open end. The inner tube 40 is appropriately referred to as a “hollow cylinder 40”.

The suspension spring 53 is a compression coil spring. A lower end of the suspension spring 53 is provided inside the inner tube 40. The suspension spring 53 applies a force to the outer tube 30 and the inner tube 40 in a direction away from each other along the center line CL.

The cylinder 60 is a cylindrical member. An upper end 61 of the cylinder 60 is a closed end and is screwed to an inner peripheral surface of the upper end 31 of the outer tube 30. The upper end 31 of the outer tube 30 and the upper end 61 of the cylinder 60 are sealed with a sealing material. The cylinder 60 is appropriately referred to as a “hollow cylinder 60”.

The first rod 70 is a hollow conductor. A lower end 71 of the first rod 70 is screwed to the bottom bolt 52. As described above, the first rod 70 is located on the center line CL (axis CL) of the outer tube 30 and is provided to be movable relative to the outer tube 30 in the axial direction. The first rod 70 is appropriately referred to as a “rod pipe 70”.

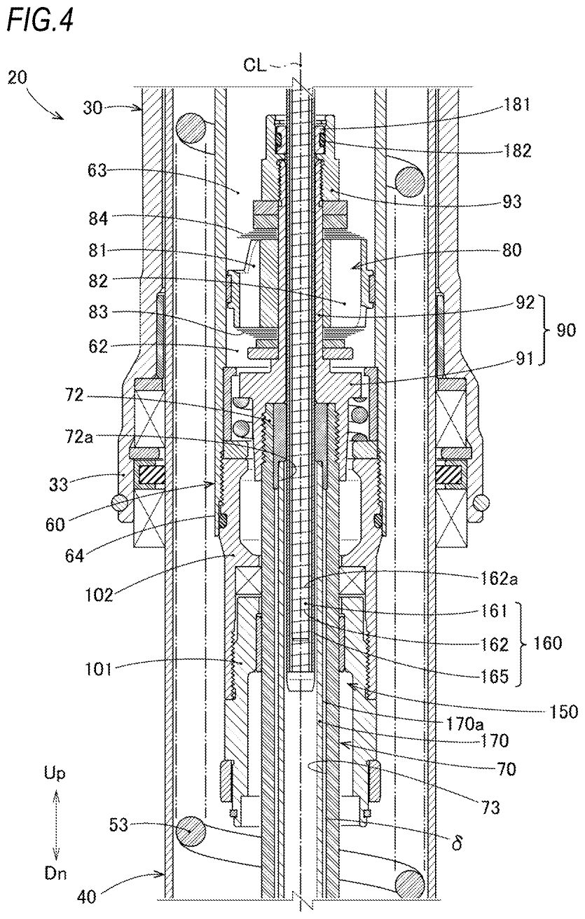

As illustrated in FIG. 4, the first piston 80 is integrally connected to the upper end 72 of the first rod 70 and can advance and retreat inside the cylinder 60 in the up-down direction. The inside of the cylinder 60 is divided by the first piston 80 into a first chamber 62 below the first piston 80 and a second chamber 63 above the first piston 80. Oil is accommodated in the first chamber 62 and the second chamber 63.

The first piston 80 includes a first flow path 81 and a second flow path 82. The first flow path 81 and the second flow path 82 communicate the first chamber 62 and the second chamber 63. A first valve 83 which opens when the hydraulic shock absorber 20 contracts is provided at a lower end of the first flow path 81, and when the first valve 83 opens, a second liquid chamber 63 and a first liquid chamber 62 communicate with each other. A second valve 84 which opens when the hydraulic shock absorber 20 extends is provided at an upper end of the second flow path 82, and when the second valve 84 opens, the first liquid chamber 62 and the second liquid chamber 63 communicate with each other. The first valve 83 and the second valve 84 have a configuration in which a large number of plate valves are laminated.

A tubular first fixing member 90 penetrating along the center line CL is screwed to an outer peripheral surface of the upper end 72 of the first rod 70. The first fixing member 90 includes a bottomed tubular base portion 91 having an opening at the bottom and a cylindrical extending portion 92 extending upward from the base portion 91 along the center line CL. The base portion 91 is screwed to the upper end 72 of the first rod 70. The extending portion 92 penetrates the first piston 80 vertically and a first nut 93 is screwed to an upper end portion of the extending portion 92. The first nut 93 is provided above the first piston 80. As a result, the first piston 80 is connected to the upper end 72 of the first rod 70 by using the first fixing member 90. That is, the first fixing member 90 fixes the first piston 80 in the axial direction of the first rod 70 by the first nut 93.

In the first rod 70, a portion below the upper end 72 screwed to the first fixing member 90 is accommodated in a guide connecting portion 102 fixed to a lower end 64 of the cylinder 60 and a rod guide 101 fixed to the guide connecting portion 102.

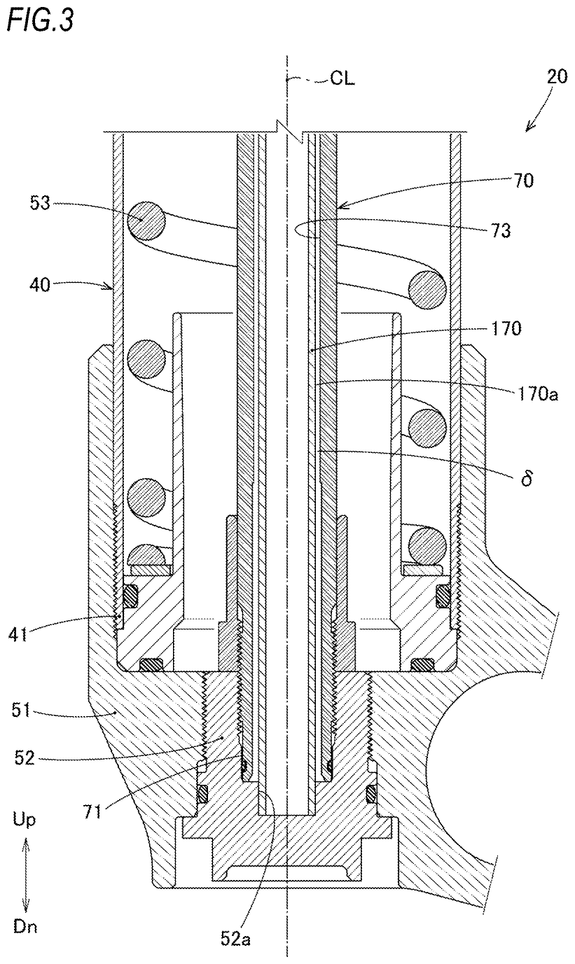

As illustrated in FIGS. 3 to 5, the lower end 71 of the first rod 70 is fixed to the lower end 41 of the inner tube 40 via the bottom bolt 52 and the axle bracket 51. The upper end 61 of the cylinder 60 is fixed to the upper end 31 of the outer tube 30. When the shock absorber 20 is maximally extended, that is, when the inner tube 40 is maximally extended in the axial direction with respect to the outer tube 30, the first piston 80 is prevented from moving below the lower end 64 by the guide connecting portion 102 fixed to the lower end 64 of the cylinder 60. When the shock absorber 20 is maximally extended, the first rod 70 receives an axial force. As such, the first rod 70 is provided inside the inner tube 40 in a form that receives an axial force.

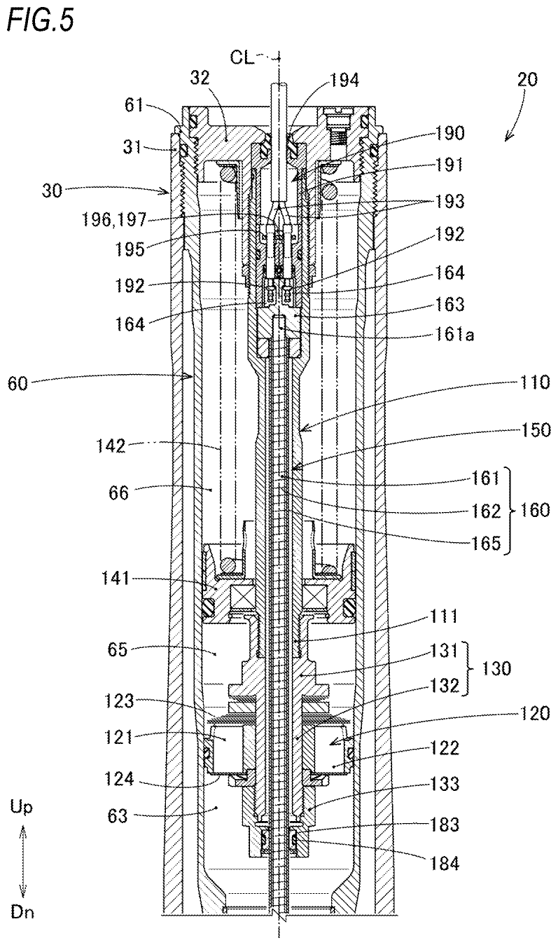

As illustrated in FIG. 5, the second rod 110 is a hollow member.

As illustrated in FIG. 5, the second piston 120 is integrally connected to the lower end 111 of the second rod 110 and can move forward and backward in the axial direction inside the cylinder 60. The inside of the cylinder 60 is divided by the second piston 120 into the second chamber 63 below the second piston 120 and a third chamber 65 above the second piston 120. Oil is accommodated in the first chamber 62 and the third chamber 65.

The second piston 120 includes a first flow path 121 and a second flow path 122. A first valve 123 is provided at an upper end of the first flow path 121 and a second valve 124 is provided at a lower end of the second flow path 122. By opening the first valve 123 or the second valve 124, the second chamber 63 and the third chamber 65 communicate with each other.

A hollow second fixing member 130 having a hole penetrating along the center line CL is screwed to an outer peripheral surface of the lower end 111 of the second rod 110. The second fixing member 130 includes a bottomed tubular base portion 131 having an upper opening and a cylindrical extending portion 132 extending downward along the center line CL from the base portion 131. The base portion 131 is screwed to the lower end 111 of the second rod 110. The extending portion 132 penetrates the center of the second piston 120 up and down and a second nut 133 is screwed to a lower end of the extending portion 132. The second nut 133 is located below the second piston 120. As a result, the second piston 120 is fixed to the lower end 111 of the second rod 110 by using the second fixing member 130.

A free piston 141 is provided to be movable in the axial direction at a portion above the lower end 111 of the second rod 110. The free piston 141 can move forward and backward in the axial direction inside the cylinder 60 and a downward force in the axial direction is applied by a spring 142. The inside of the cylinder 60 above the second piston 120 is divided by the free piston 141 into the third chamber 65 below the free piston 141 and a fourth chamber 66 above the free piston 141.

As illustrated in FIGS. 4 to 6, the shock absorber 20 includes a stroke sensor 150. The stroke sensor 150 includes a hollow conductor first rod 70 and a coil unit 160 which moves back and forth in the first rod 70.

An upper part of a coil unit 160 is accommodated in the second rod 110. The coil unit 160 includes a rod-shaped support body 161 extending from the second rod 110 to the inside of the first rod 70 and a coil 162 provided on the support body 161 by being wound around an outer peripheral surface of the support body 161.

An upper end 161a of the support body 161 is fixed by a coil terminal portion 163 accommodated inside the second rod 110. The support body 161 is located on the center line CL. The support body 161 passes from the coil terminal portion 163 to the inside of the second rod 110, the inside of the second fixing member 130, the inside of the second nut 133, the inside of the first nut 93, the inside of the first fixing member 90, and the inside of the first rod 70 and is provided to be able to move forward and backward in the axial direction with respect to the first rod 70.

The coil 162 is connected to terminals 164 and 164 provided at an upper end of the coil terminal portion 163. The coil 162 has a characteristic that the inductance increases as the temperature rises. An outer peripheral surface 162a of the coil 162 is preferably covered with a covering material 165. When the outer peripheral surface 162a of the coil 162 is covered with the covering material 165, an outer peripheral surface of the covering material 165 corresponds to the outer peripheral surface 162a of the coil 162.

As the shock absorber 20 expands or contracts, an insertion length (fitting length) of the first rod 70 with respect to the coil 162 changes. Here, when an alternating current is flowing through the coil 162, an eddy current is generated to cancel the fluctuation of the magnetic field and the inductance of the coil 162 changes. The stroke amount of the shock absorber 20 can be figured out by using the change in inductance.

Between an inner peripheral surface 73 of the first rod 70 and the outer peripheral surface 162a (outer peripheral surface of the covering material 165 covering the coil 162) of the coil 162, a hollow intermediate member 170 is provided in a form that allows axial movement. As illustrated in FIG. 3, the bottom bolt 52 includes a first support portion 52a which is located on the center line CL and is recessed to open upward. A lower end of the intermediate member 170 is loosely fitted (gap-fitted) with the first support portion 52a to move forward and backward in the axial direction. As illustrated in FIG. 4, the upper end 72 of the first rod 70 includes a second support portion 72a located on the center line CL and recessed to open downward. The upper end of the intermediate member 170 is loosely fitted (gap-fitted) with the second support portion 72a to move forward and backward in the axial direction. The intermediate member 170 is allowed to move in the axial direction within a predetermined range between a bottom surface of the first support portion 52a and a bottom surface of the second support portion 72a.

As described above, the intermediate member 170 is not press-fitted or fastened by other members 52 and 70 (bottom bolt 52 and first rod 70) provided around the intermediate member 170, so it is possible to move in the axial direction and in a direction intersecting the axial direction. Since the intermediate member 170 is provided in a form that allows axial movement, when the first rod 70 receives an axial force, the intermediate member 170 can move forward and backward in the axial direction with respect to the first rod 70. Since the axially movable intermediate member 170 is less susceptible to axial forces than the first rod 70, the intermediate member 170 can be formed of a material which has less tensile strength than the first rod 70.

By interposing an elastic member between the intermediate member 170 and the first support portion 52a and between the intermediate member 170 and the second support portion 72a, the intermediate member 170 can be provided in a movable form in the axial direction and in the direction intersecting the axial direction without providing a gap at the upper end or the lower end of the intermediate member 170.

Between the inner peripheral surface 73 of the first rod 70 and an outer peripheral surface 170a of the intermediate member 170, it is provided with a gap δ which can reduce a force transmitted from the first rod 70 to the intermediate member 170 when the first rod 70 is bent and deformed by receiving a force in the axial direction or in the direction intersecting the axial direction.

The intermediate member 170 is made of a material having higher magnetic permeability and higher conductivity than the first rod 70 and is located on the center line CL. Examples of the material having high magnetic permeability include gold, silver, copper, chrome steel, beryllium copper and the like and it is preferable that the intermediate member 170 is made of beryllium copper (including beryllium copper alloy). By forming the intermediate member 170 with a material having high magnetic permeability, the performance of the stroke sensor 150 can be improved while maintaining the strength of the first rod 70.

As illustrated in FIG. 4, the rod-shaped support body 161 and the outer peripheral surface 162a (outer peripheral surface of the covering material 165) of the coil 162 wound around the support body 161 are supported by the first nut 93 via a first bush 181 and a first elastic body 182. The first bush 181 is an annular member made of resin and guides the support body 161 and the coil 162 to be slidable in the axial direction along the center line CL. The first elastic body 182, which is a rubber annular member (preferably an O-ring), is fitted into a groove provided in the outer peripheral surface of the first bush 181. The outer diameter of the first elastic body 182 is larger than the outer diameter of the first bush 181. As a result, the support body 161 and the coil 162 are allowed to move in the direction intersecting the axial direction.

Similarly, as illustrated in FIG. 5, the support body 161 and the outer peripheral surface 162a (outer peripheral surface of the covering material 165) of the coil 162 are supported by the second nut 133 via a second bush 183 and a second elastic body 184. The second bush 183 is an annular member made of resin and guides the support body 161 and the coil 162 to be slidable in the axial direction along the center line CL. The second elastic body 184, which is a rubber annular member (preferably an O-ring), is fitted into a groove provided in the outer peripheral surface of the second bush 183. The outer diameter of the second elastic body 184 is larger than the outer diameter of the second bush 183. As a result, the support body 161 and the coil 162 are allowed to move in the direction intersecting the axial direction.

As described above, the support body 161 and the coil 162 are supported by the first nut 93 and the second nut 133 in a state where the swing in the direction intersecting the center line CL is allowed. As a result, a part of the bending force applied to the support body 161 and the coil 162 can be absorbed by the first elastic body 182 and the second elastic body 184, so that the support body 161 and the coil 162 can be made difficult to bend. When the bending force is applied, it is difficult for the first bush 181 in contact with the coil 162 and the first nut 93 supporting the coil 162 to come into contact with each other and it is difficult for the second bush 183 in contact with coil 162 and the second nut 133 supporting coil 162 to come into contact with each other. Thereby, it is possible to provide the shock absorber 20 having improved durability against the bending force.

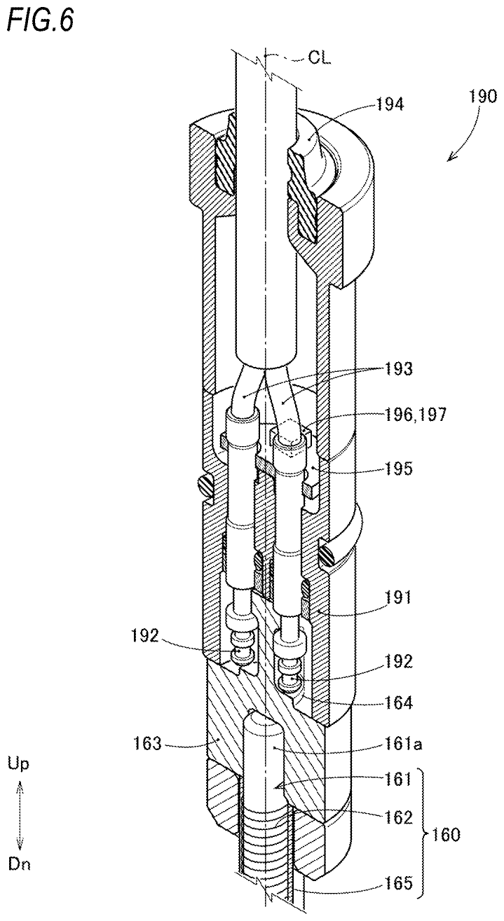

As illustrated in FIGS. 5 and 6, an inner upper end of the second rod 110 is closed by the fork bolt 32. Inside the second rod 110, a cable connection unit 190 is detachably attached together with the coil terminal portion 163. The cable connection unit 190 includes a tubular socket 191 which overlaps an upper end of the coil terminal portion 163 and covers the terminals 164 and 164 and cable harnesses 193 and 193 which are detachably connected to the terminals 164 and 164 via external terminals 192 and 192 and extend from the socket 191 to the outside. The socket 191 is located on the center line CL of the second rod 110. The cable harnesses 193 and 193 are connected to a control unit (not illustrated). The socket 191 uses a grommet 194 to seal a portion where the cable harnesses 193 and 193 are pulled out.

As described above, the shock absorber 20 includes the cable harnesses 193 and 193 connected to the coil 162. The cable harnesses 193 and 193 are led from the upper end 31 of the outer tube 30 (cylinder body 30) to the outside of the outer tube 30. That is, since the cable harnesses 193 and 193 are guided to the outside from the upper end of the shock absorber 20 assembled to the motorcycle 10 (saddle-riding vehicle 10), the cable harnesses 193 and 193 are provided at a relatively high position from a traveling road surface. Therefore, the cable harnesses 193 and 193 are less affected by external factors such as stepping stones and muddy water that may occur during the running of the motorcycle 10. As a result, the durability of the stroke sensor 150 can be improved and the risk of failure can be reduced. Therefore, the reliability of detection by the stroke sensor 150 can be improved.

Since the cable harnesses 193 and 193 are guided from the upper end 31 of the outer tube 30 to the outside of the outer tube 30, the length to other parts of motorcycle 10 can be shortened as compared with the case where it is guided to the outside from the lower end of the shock absorber 20. The cost can be reduced as the length is shortened.

The cable connection unit 190 includes a substrate 195 provided inside the socket 191 and temperature compensation correction unit 196 mounted on the substrate 195. The correction unit 196 corrects the stroke amount of the shock absorber 20 detected by using the coil 162 by using the temperature in the shock absorber 20. The correction unit 196 is composed of, for example, a capacitor 197. The capacitor 197 has a characteristic that the capacitance decreases as the temperature rises. The capacitor 197 is, for example, a ceramic capacitor.

As described above, the shock absorber 20 includes the correction unit 196 which corrects the stroke amount of the shock absorber 20 detected by using the coil 162 by using the temperature. The correction unit 196 is built in the outer tube 30 (cylinder body 30).

The coil 162 used in the stroke sensor 150 has a characteristic that the inductance increases as the temperature rises. On the other hand, the shock absorber 20 includes the temperature compensation correction unit 196. Therefore, the influence of the temperature rise of the hydraulic shock absorber 20 on the inductance characteristic of the coil 162 can be eliminated as much as possible. As a result, it is possible to make it difficult for an error to occur in the stroke amount detected by the stroke sensor 150. Thereby, it is possible to provide the hydraulic shock absorber 20 having improved the temperature characteristics of the stroke sensor 150.

The description of the first example is summarized as follows. The shock absorber 20 includes the hollow cylinder body 30 (outer tube 30) extending in the up-down direction and the rod pipe 70 (first rod 70) which is located on the axis CL of the cylinder body 30, is provided to be relatively movable in the axial direction of the cylinder 30 with respect to the cylinder body 30, and is a hollow member provided to receive the axial force. The shock absorber 20 includes the rod-shaped support body 161 to which the upper end 161a is fixed and which extends into the rod pipe 70 and the stroke sensor 150 having the coil 162 and a conductor provided to be able to detect the relative displacement of the rod pipe 70 with respect to the support body 161. In the stroke sensor 150, the conductor is the rod pipe 70 and the coil 162 is wound around the outer peripheral surface of the support body 161. Between the inner peripheral surface 73 of the rod pipe 70 (first rod 70) and the support body 161, the shock absorber 20 includes the hollow intermediate member 170 provided in a form that allows the axial movement.

Therefore, even when the rod pipe 70 is elastically deformed by receiving an axial force, the intermediate member 170 is not easily affected. The intermediate member 170 can prevent the coil 162 provided inside the intermediate member 170 from receiving an excessive force. Therefore, it is possible to provide the shock absorber 20 including the stroke sensor 150 with improved durability.

The shock absorber 20 includes the outer tube 30 which is composed of the cylinder body 30 and in which the upper end 31 is the closed end and the lower end 33 is the open end and the inner tube 40 in which the upper end 42 is the open end and the lower end 41 is the closed end and which is provided so that a part thereof can be moved forward and backward with respect to the inside of the outer tube 30. The shock absorber 20 includes the cylinder 60 extending from the upper end 31 of the outer tube 30 to the inside of the inner tube 40. The shock absorber 20 includes the first rod 70 (rod pipe 70), which is composed of the rod pipe 70 and extends from the lower end 41 of the inner tube 40 to the inside of the cylinder 60, and the first piston 80, which is fixed to the upper end 72 of the first rod 70 and divides the inside of the cylinder 60 into the lower first liquid chamber 62 and the upper second liquid chamber 63. The shock absorber 20 includes the hollow second rod 110 extending from the upper end 31 of the outer tube 30 to the inside of the cylinder 60 and the second piston 120 fixed to the lower end 111 of the second rod 110. The upper end 161a of the support body 161 is fixed to the second rod 110. The support body 161 is inserted inside the second rod 110.

Therefore, it is possible to provide the shock absorber 20 which forms an inverted front fork incorporating the stroke sensor 150 with higher durability and detection accuracy.

In the above explanation, the stroke sensor 150 in which a stroke amount is specified by using changes in inductance when the support body 161 with the coil 162 wound around the outer peripheral surface moves forward and backward inside the rod pipe 70, which is a conductor, is exemplified. However, the stroke sensor in the invention is not limited thereto. The stroke sensor in the invention can also have a form in which a support body, which is a conductor, advances and retreats in a rod pipe provided with a coil on an inner peripheral surface. However, from the viewpoint of reducing costs, when the cable harness 193 is guided from the upper end 31 of the outer tube 30 to the outside of the outer tube 30, it is preferable to use the stroke sensor in which the support body 161 having the coil 162 wound around the outer peripheral surface moves forward and backward in the rod pipe 70, which is a conductor.

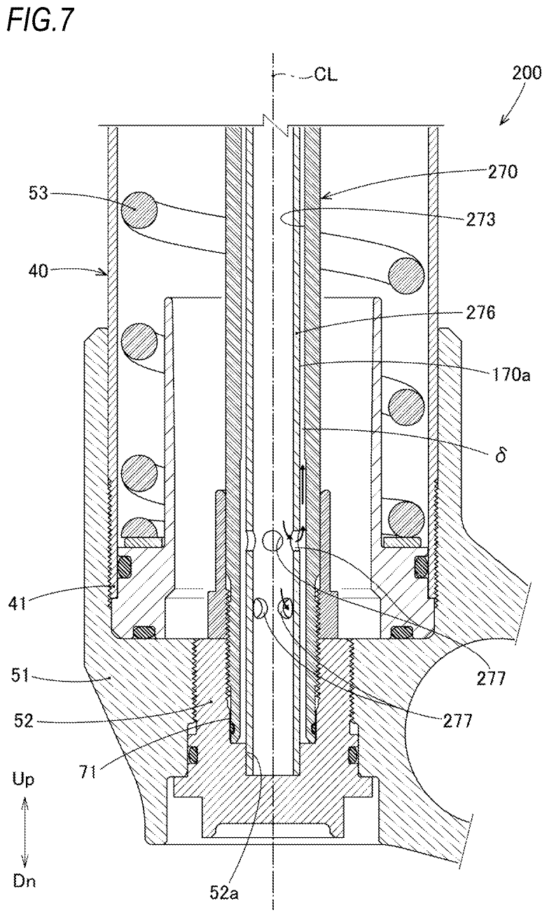

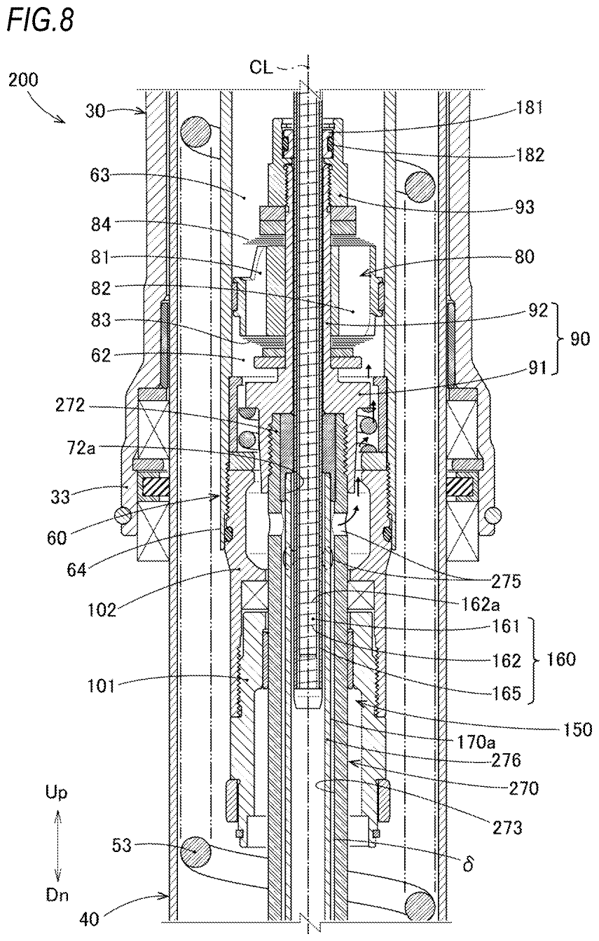

Next, the shock absorber 200 of a second example will be described with reference to FIGS. 7 and 8.

### Second Example

FIG. 7 is an enlarged view illustrating a lower part of the shock absorber 200 and is illustrated in correspondence with FIG. 3 for explaining the shock absorber 20 of the first example. FIG. 8 is an enlarged view illustrating an intermediate portion in the axial direction of a shock absorber 200 and is shown in correspondence with FIG. 4 for explaining the shock absorber 20 of the first example.

The shock absorber 200 of the second example is characterized in that a first rod 270 corresponding to the first rod 70 illustrated in FIGS. 3 and 4 is provided with a first through hole 275 penetrating in a radial direction thereof and an intermediate member 276 corresponding to the intermediate member 170 illustrated in FIGS. 3 and 4 is provided with a second through hole 277 penetrating in the radial direction thereof. Other basic configurations are the same as those of the shock absorber 20 of the first example. In the description of the shock absorber 200, the same reference numerals are used for the parts common to the shock absorber 20 and detailed description thereof will be omitted.

As illustrated in FIG. 8, the first rod 270 has at least one first through hole 275 which penetrates in the radial direction thereof. The first through hole 275 is located at an upper end portion (a portion below an upper end 272 and accommodated in the guide connecting portion 102) of the first rod 270. As illustrated in FIG. 7, the intermediate member 276 has at least one second through hole 277 which penetrates in the radial direction thereof. The second through hole 277 is located at a lower end portion of the intermediate member 276. The inside of the intermediate member 276 communicates with the chamber 62 (first chamber 62) provided outside the first rod 270 through the second through hole 277 and the first through hole 275.

When the hydraulic shock absorber 200 contracts, the coil unit 160 enters the intermediate member 276. Therefore, oil the volume of a part of the coil unit 160 which entered the intermediate member 276 flows from the inside of the intermediate member 276 through the second through hole 277 into the gap δ between an inner peripheral surface 273 of the first rod 270 and the intermediate member 276. The oil which has flowed into the gap δ from the inside of the intermediate member 276 then flows into the first chamber 62 through the first through hole 275 of the first rod 270. On the other hand, when the hydraulic shock absorber 200 is extended, the coil unit 160 exits from the intermediate member 276. Therefore, oil of the volume of a part of the coil unit 160 which has exited from the intermediate member 276 flows from the first chamber 62 through the first through hole 275, the gap δ, and the second through hole 277 into the inside of the intermediate member 276. As a result, a damping force in a contraction stroke and an expansion stroke of the hydraulic shock absorber 200 can be reduced. Since it becomes easy to prevent the support member 161 and the coil 162 from bending, it becomes easy to improve the durability of the stroke sensor 150.

That is, in the contraction stroke of the hydraulic shock absorber 200, the first through hole 275, the gap δ between the inner peripheral surface 273 of the rod pipe 270 and the intermediate member 276, and the second through hole 277 and the inside of the intermediate member 276 can be utilized as an oil flow path. Therefore, the damping force in the contraction stroke of the hydraulic shock absorber 200 can be reduced. Hereinafter, the first through hole 275, the gap δ between the inner peripheral surface 273 of the rod pipe 270 and the intermediate member 276, the second through hole 277, and the inside of the intermediate member 276 will be referred to as an “oil flow path”.

By circulating the oil accumulated in the oil flow path, the hardness of the hydraulic shock absorber 200 at the time of stroke can be reduced.

Since the first through hole 275 is located at an upper end portion of the first rod 270 and the second through hole 277 is located at a lower end portion of the intermediate member 276, the oil in the oil flow path can be efficiently circulated.

The other actions and effects of the second example are the same as the actions and effects of the first example described above.

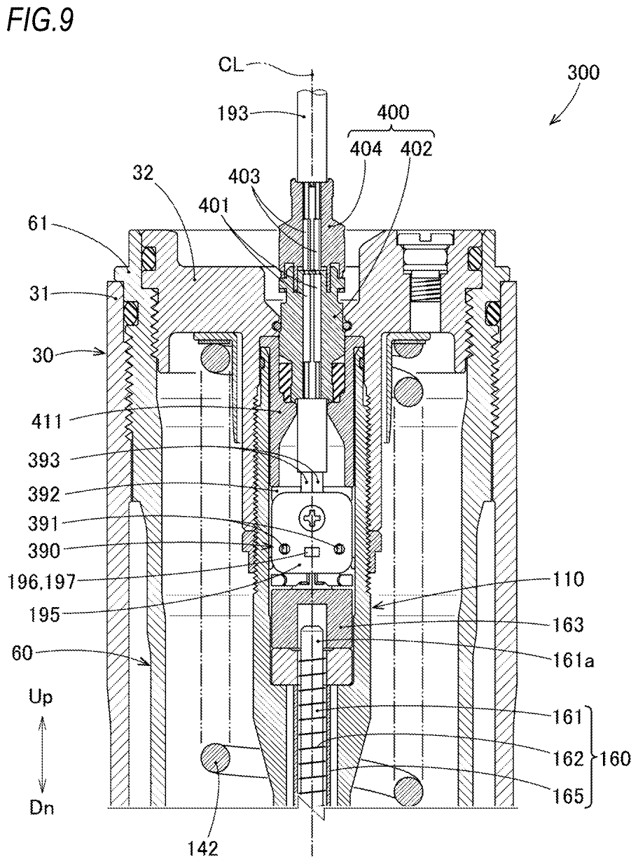

Next, a shock absorber 300 of a third example will be described with reference to FIGS. 9 to 11.

### Third Example

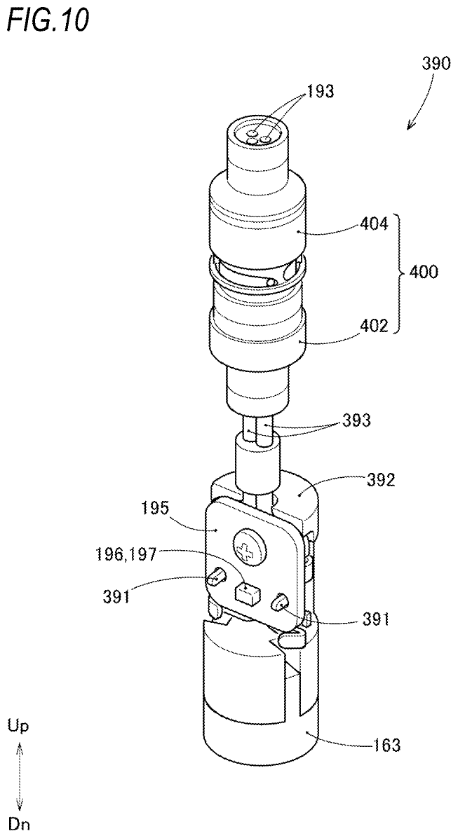

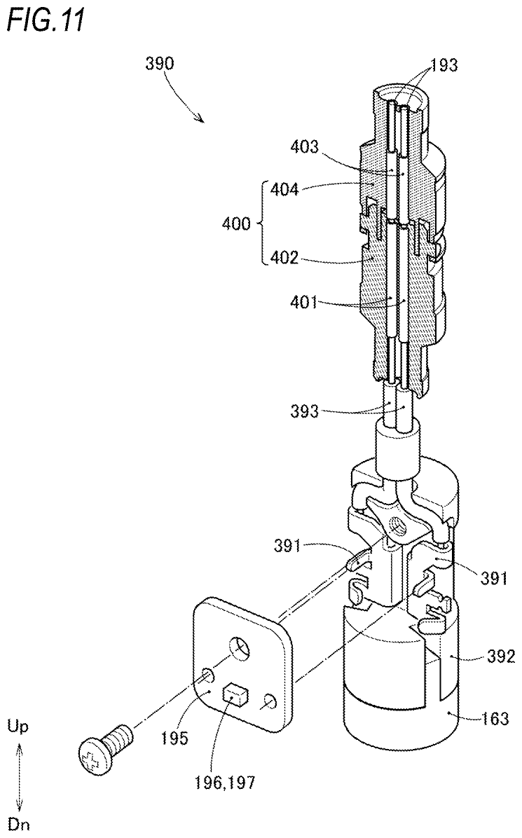

FIG. 9 is an enlarged view illustrating an upper portion of the shock absorber 300 provided with a cable connection unit 390 and is illustrated in correspondence with FIG. 5 for explaining the shock absorber 20 of the first example. FIG. 10 is an enlarged view illustrating an appearance of the cable connection unit 390 and is illustrated in correspondence with FIG. 6 for explaining the shock absorber 20 of the first example. FIG. 11 is an enlarged view illustrating a cross section of the cable connection unit 390 and is illustrated in correspondence with FIG. 6 for explaining the shock absorber 20 of the first example.

The shock absorber 300 of the third example is characterized in that the cable connection unit 190 in the shock absorber 10 of the first example illustrated in FIGS. 5 and 6 is changed to the cable connection unit 390 illustrated in FIGS. 9 to 11 and other basic configurations are the same as those of the shock absorber 20 of the first example. In the description of the shock absorber 300, the same reference numerals are used for the parts common to the shock absorber 20 and detailed description thereof will be omitted.

The shock absorber 300 of the third example can also be applied to the shock absorber 200 of the second example illustrated in FIGS. 7 and 8. That is, although the cable connection unit 390 can be incorporated into the shock absorber 200 of the second embodiment, the description thereof will be omitted.

The cable connection unit 390 of the third example includes a terminal holder 392 incorporating terminals 391 and 391 to which the coil 162 is connected, a connector 400 connected to the terminals 391 and 391 via electric wires 393 and 393, and cable harnesses 193 and 193 extending from the connector 400 to the outside.

The connector 400 includes a first connector 402 having first connection end portions 401 and 401 (first terminal pins 401 and 401) connected to the electric wires 393 and 393 and a second connector 404 having second connection end portions 403 and 403 (second terminal pins 403 and 403) which can be in contact with the first connection end portions 401 and 401. The terminal holder 392, the electric wires 393 and 393, and a part of the first connector 402 are accommodated inside the second rod 110.

The first connector 402 is held by a tubular socket 411 provided inside the second rod 110 and is exposed from the upper end of the fork bolt 32. Upper end surfaces of the first connection end portions 401 and 401 are located at an open upper end of the first connector 402. The socket 411 is located on the center line CL of the second rod 110.

The second connector 404 is detachably incorporated with respect to the upper end of the first connector 402. One of the first connector 402 and the second connector 404 is a female connector and the other is a male connector that is detachably fitted to the female connector. For example, the connector 400 has a cassette type configuration, which is a so-called one-touch coupler, in which the second connector 404 can be easily attached to and detached from the first connector 402 by a one-touch operation method. The cable harnesses 193 and 193 are connected to the second connection end portions 403 and 403 of the second connector 404.

As described above, the cable connection unit 390 of the third example is characterized in that the coil 162 and the cable harnesses 193 and 193 are connected via the detachable connector 400. As a result, since the cable harnesses 193 and 193 can be easily attached or detached, the workability of attaching or detaching the shock absorber 300 to the saddle-riding vehicle 10 and the workability of routing the cable harnesses 193 and 193 are improved and the maintainability of the shock absorber 300 is improved. When a failure such as disconnection occurs in the cable harnesses 193 and 193 itself due to an external factor, the coil unit 160 can be continuously used by simply replacing the cable harnesses 193 and 193.

The cable connection unit 390 and coil unit 160 are incorporated into the fork bolt 32. The fork bolt 32 is detachably attached directly or indirectly to the upper end 31 of the outer tube 30 (cylinder body 30). Therefore, the cable connection unit 390 and the coil unit 160 can be easily removed only by removing the fork bolt 32 from the upper end 31 of the outer tube 30. As a result, the maintenance of the cable connection unit 390 and the coil unit 160 is enhanced.

The cable connection unit 390 includes the substrate 195 attached to the terminal holder 392 and the correction unit 196 mounted on the substrate 195. Therefore, it is easy to attach the correction unit 196 to the shock absorber 300.

The other actions and effects of the third example are the same as the actions and effects of the first example and the second example described above.

More specifically, the shock absorber 300 includes the tubular outer tube 30 with the upper end 31 as the closed end and the lower end 33 as the open end, the tubular inner tube 40 with the upper end 42 as the open end and the lower end 41 as the closed end where a part thereof is provided to be able to move forward and backward with respect to the inside of the outer tube 30, and the tubular cylinder 60 extending from the upper end 31 of the outer tube 30 to the inside of the inner tube 40. The shock absorber 300 includes the hollow conductor rod pipe 270 (first rod 270) which extends from the lower end 41 of the inner tube 40 to the inside of the cylinder 60 and is provided to be movable relative to the cylinder 60 in the axial direction of the cylinder 60 and the piston 80 (first piston 80) connected to the upper end 272 of the rod pipe 270 and partitioning the inside of the cylinder 60 into the lower first liquid chamber 62 and the upper second liquid chamber 63. The shock absorber 300 includes the support body 161 which is a rod-shaped conductor extending from the upper end 31 of the outer tube 30 to the inside of the rod pipe 270 through the piston 80, and the stroke sensor 150 including the coil 162 provided inside the rod pipe 270 to be able to detect the relative displacement of the support body 161 with respect to the rod pipe 270. Between the inner peripheral surface 273 of the rod pipe 270 and the outer peripheral surface 162a of the coil 162, the shock absorber 300 includes the hollow intermediate member 276 which is provided in a form that allows movement in the axial direction and made of a material having higher magnetic permeability than the rod pipe 270. The shock absorber 300 includes the cable harnesses 193 and 193 which are connected to the coil 162 via the detachable connector 400 and is guided to the outside from the upper end 31 of the outer tube 30 and the correction unit 196 which is built in the cylinder body 30 and corrects a position of the rod pipe 270 with respect to the support body 161, the position is detected by using the coil 162, based on the temperature. The rod pipe 270 has the first through hole 275 at its upper end portion that penetrates in its radial direction. The intermediate member 276 has a second through hole 277 at its lower end portion that penetrates in its radial direction. The inside of the intermediate member 276 communicates with the first liquid chamber 62 through the second through hole 277 and the first through hole 275.

The shock absorber according to the invention is not limited to the above-described examples as long as the actions and effects of the invention are exhibited. For example, the shock absorbers 20, 200, and 300 of the first example to the third example described above can be combined with any two or all of them. For example, a shock absorber having the configuration illustrated in FIGS. 7 to 8 and the configuration illustrated in FIGS. 9 to 11 is also included in the invention.

The shock absorbers 20, 200, and 300 of the invention are suitable for mounting as a front fork of a saddle-riding vehicle.

What is claimed is:

1. A shock absorber comprising:
a hollow cylinder body extending in an up-down direction;
a rod pipe which is a hollow member located on an axis of the cylinder body, provided to be relatively movable in an axial direction of the cylinder body with respect to the cylinder body, and provided in a form of receiving a force in the axial direction;
a rod-shaped support body extending inside the rod pipe with an upper end fixed; and
a stroke sensor including a coil and a conductor provided to be able to detect relative displacement of the rod pipe with respect to the support body, wherein
in the stroke sensor, the conductor is the rod pipe and the coil is wound around an outer peripheral surface of the support body, or the conductor is the support body and the coil is provided on an inner peripheral surface of the rod pipe, and
the shock absorber further comprises a hollow intermediate member provided between the inner peripheral surface of the rod pipe and the support body to allow movement in the axial direction.

2. The shock absorber according to claim 1, wherein
the rod pipe has a first through hole which penetrates in a radial direction of the rod pipe,
the intermediate member has a second through hole which penetrates in a radial direction of the intermediate member, and
an inside of the intermediate member communicates with a chamber provided outside the rod pipe through the second through hole and the first through hole.

3. The shock absorber according to claim 1, further comprising:
a cable harness connected to the coil, wherein
the cable harness is guided from an upper end of the cylinder body to an outside of the cylinder body.

4. The shock absorber according to claim 3, wherein
the coil and the cable harness are connected via a detachable connector.

5. The shock absorber according to claim 1, wherein
the intermediate member is made of a material having higher magnetic permeability than the rod pipe.

6. The shock absorber according to claim 1, further comprising:
correction unit to correct a position of the rod pipe with respect to the support body detected by using the coil based on a temperature in the shock absorber, wherein
the correction unit is provided in the cylinder body.

7. The shock absorber according to claim 1, further comprising:
an outer tube composed of the cylinder body, with an upper end as a closed end and a lower end as an open end;
an inner tube with an upper end as an open end and a lower end as a closed end, where a part of the inner tube can move forward and backward with respect to an inside of the outer tube;
a cylinder extending from the upper end of the outer tube to an inside of the inner tube,
a first rod which is composed of the rod pipe and extends from the lower end of the inner tube to an inside of the cylinder;
a first piston which is fixed to an upper end of the first rod and divides the inside of the cylinder into a lower first liquid chamber and an upper second liquid chamber;
a hollow second rod extending from the upper end of the outer tube to the inside of the cylinder; and
a second piston which is fixed to a lower end of the second rod, wherein
an upper end portion of the support body is fixed to the second rod, and
the support body is inserted inside the second rod.

8. A shock absorber comprising:
a tubular outer tube with an upper end as a closed end and a lower end as an open end;
a tubular inner tube with an upper end as an open end and a lower end as a closed end, where a part of the inner tube can move forward and backward with respect to an inside of the outer tube;
a tubular cylinder extending from the upper end of the outer tube to an inside of the inner tube;
a rod pipe, which is a hollow conductor, extending from the lower end of the inner tube to an inside of the cylinder and provided to be movable relative to the cylinder in an axial direction of the cylinder;
a piston which is connected to an upper end of the rod pipe and divides the inside of the cylinder into a lower first liquid chamber and an upper second liquid chamber;
a stroke sensor which includes a support body, which is a rod-shaped conductor extending from the upper end of the outer tube through the piston to an inside of the rod pipe, and a coil provided inside the rod pipe so that a relative displacement of the support body with respect to the rod pipe can be detected;
a hollow intermediate member which is provided in a form that allows movement in the axial direction between an inner peripheral surface of the rod pipe and an outer peripheral surface of the coil and is made of a material having higher magnetic permeability than the rod pipe;
a cable harness which is connected to the coil via a detachable connector and is guided to an outside from the upper end of the outer tube; and
correction unit which is provided in the outer tube and corrects a position of the rod pipe with respect to the support body, where the position is detected by using the coil, based on a temperature in the shock absorber, wherein
the rod pipe has a first through hole which penetrates in a radial direction of the rod pipe at an upper end portion,
the intermediate member has a second through hole which penetrates in a radial direction of the intermediate member at a lower end portion, and
an inside of the intermediate member communicates with the first liquid chamber through the second through hole and the first through hole.

9. The shock absorber according to claim 2, further comprising:
a cable harness connected to the coil, wherein
the cable harness is guided from an upper end of the cylinder body to an outside of the cylinder body.

10. The shock absorber according to claim 9, wherein
the coil and the cable harness are connected via a detachable connector.

11. The shock absorber according to claim 2, wherein
the intermediate member is made of a material having a higher magnetic permeability than the rod pipe.

12. The shock absorber according to claim 3, wherein
the intermediate member is made of a material having a higher magnetic permeability than the rod pipe.

13. The shock absorber according to claim 9, wherein
the intermediate member is made of a material having a higher magnetic permeability than the rod pipe.

14. The shock absorber according to claim 4, wherein
the intermediate member is made of a material having a higher magnetic permeability than the rod pipe.

15. The shock absorber according to claim 10, wherein
the intermediate member is made of a material having a higher magnetic permeability than the rod pipe.

16. The shock absorber according to claim 2, further comprising:
correction unit to correct a position of the rod pipe with respect to the support body detected by using the coil based on a temperature in the shock absorber, wherein
the correction unit is provided in the cylinder body.

17. The shock absorber according to claim 3, further comprising:
correction unit to correct a position of the rod pipe with respect to the support body detected by using the coil based on a temperature in the shock absorber, wherein
the correction unit is provided in the cylinder body.

18. The shock absorber according to claim 5, further comprising:
correction unit to correct a position of the rod pipe with respect to the support body detected by using the coil based on a temperature in the shock absorber, wherein
the correction unit is provided in the cylinder body.
